(19) United States
(12) Patent Application Publication
(10) Pub. No.: US 2004/0236804 A1
(43) Pub. Date: Nov. 25, 2004

(54) Monitoring and data exchange procedure for a peripheral data storage unit

(76) Inventors: Pieter Bots, Berlin (DE); Carsten Russ, Berlin (DE); Axel Lucassen, Voorburg (NL); Herman Perk, Berlin (DE)

Correspondence Address: NILS H. LJUNGMAN, NILS H. LJUNGMAN & ASSOCIATES, P.O. BOX 130, GREENSBURG, PA, 15601-0130, US

(21) Appl. No.: 10/784,120

(22) Filed: Feb. 20, 2004

Related U.S. Application Data
(63) Continuation-in-part of application No. PCT/DE03/00746, filed on Mar. 4, 2003.

(30) Foreign Application Priority Data
Mar. 6, 2002 (DE) 102 09 712.7

(51) Int. Cl. G06F 17/00

(52) U.S. Cl. 707/204

(57) ABSTRACT

A procedure for operating an external data storage unit comprising at least one stationary computer unit and one external data storage unit connectable to the computer unit via a port and a data connection. In the stationary computer unit, an operating program substantially continuously monitors possible ports for a data connection with an external data storage unit and, simultaneously, in case of a data connection via a port with an external data storage unit, monitors whether a pulse generator on the external data storage unit connected to the data connection has generated a voltage pulse. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/DE03/00746, filed on Mar. 4, 2003, which claims priority from Federal Republic of Germany Patent Application No. 102 09 712.7, filed on Mar. 6, 2002. International Patent Application No. PCT/DE03/00746 was pending as of the filing date of this application. The United States was an elected state in International Patent Application No. PCT/DE03/00746.

### BACKGROUND

1. Technical Field

This application relates to a procedure for monitoring and exchanging data between a peripheral data storage unit and at least one stationary computer unit, the stationary computer unit being connected to the peripheral data storage unit via at least one port and a data exchange line, and an operating program on the stationary computer unit continuously monitoring the existing port for a data connection with a peripheral data storage unit, as well as an operating program to execute the procedure.

2. Background Information

The storage, transfer, and backup of computer data are essential operations for any computer user. The transfer and backup of computer data to another storage medium or storage device has been known since the earliest days of the electronic computer. In the 1980's, when hard drives had not yet reached the gigabyte size, most backups or transfers of data from the personal computer were made directly to floppy disks such as the 3½ inch and the 5¼ inch disk. It was recognized early on that floppys only had limited utilization because of capacity limitations. They were initially limited to a capacity of around 360 kilobytes, and later expanded to 1.44 megabytes. When hard drives were developed that could store 40 or more megabytes of data, floppy disks became inconvenient and time consuming for data storage and transfer. The use of tapes to store, transfer, or backup large amounts of data therefore became more prevalent. The tape drive is an internal unit or an external unit with a removable tape cartridge on which data is stored. The original tapes only could store a minimum amount of information. Today, the tapes can store 800 megabytes or more of information. Although tapes can store a great deal of information, they are slow to transfer data to and from the computer. In order to bridge the data limitations of floppy disks and overcome the slow speeds of tapes, ZIP disk drives were developed which could transfer and store relatively large amounts of information, such as 100 megabytes or more, in a relatively quick and efficient manner. Presently, ZIP drives are being surpassed by JAZ drives which are equally as fast and store even more information. For computers that are networked, such as with a LAN system, the server can not only function as a main data storage, but also as backup data storage. This is normally accomplished with a second hard drive or with one or more tape drives. Presently, hard drives of over 20 gigabytes are commercially available at relatively low cost, so the hard drive is becoming an attractive backup device. Many computers are now being constructed with two hard drives. The first hard drive functions as the main memory storage and the second hard drive functions as an additional or backup storage device. Although the system has merit, it is not perfect.

For example, destruction of the computer itself destroys both the primary hard drive and secondary hard drive. Power surges can knock out both hard drives. Thus, in these situations, there is no backup storage. Ideally, the backup memory device is stored externally and separately from the computer so that harm to one will not harm the other.

Many storage, transfer, and backup systems require instructions from the operator. This can often times be confusing and frustrating for the novice computer user who is attempting to store or transfer data. In the alternative, such systems can be programmed so that the data transfer takes place automatically at preset hours. This requires no intervention of the operator and simplifies operation. However, automated actions by the computer are often restricted to simple backup and storage of data, and provide the user with limited flexibility or control if such is desired to perform other data transfer functions.

Many computers, such as notebook and laptop computers, do not have sufficient internal space to include an additional hard drive or to include a tape drive. In fact, most notebooks and laptops available today do not even have a floppy drive. These computers therefore must be physically hooked up to a device to transfer the information from the hard drive to another computer and vice versa for storage, backup, and data transfer procedures. This can be a complicated and time consuming procedure, and thus it may be undesirable to perform regularly. However, irregular data transfer can be problematic because important data can be lost if the laptop or notebook computer is lost, stolen, or destroyed. This is especially important for notebook and laptop computers because their size and portability makes such computers easier targets for theft and often exposes them to accidental damage during transporting.

In addition, the capabilities of today's computers permit applications requiring much more than their internal capacities in terms of computing power and memory requirement. In particular, connecting peripherals such as external hard drives, connected at existing ports, enhances the potential of current computer systems. It is frequently desirable to have the data saved on the peripheral available to a large number of computers since a direct network between the computers is usually not possible or unacceptable for security reasons. In this case, peripherals are connected to the individual computer systems and the status of each of the devices, especially the data structure, is compared with the other. These so-called backup systems analyze and then update the older data structure either on the peripheral or on the computer system with the latest version of the data record, so that the latest record is saved on both devices. After the peripheral is disconnected, it can be transported to another computer system and, after the peripheral is connected, a data comparison can again be executed followed by a data update.

Further, the comparison and mutual exchange of data between two devices, also known as data synchronization, or simply synchronization, has become increasingly widespread with the use of such devices as cellular phones that store data, personal data assistants (PDA's) or palm pilots, and other types of portable computers or data storage devices, in addition to home or business personal desktop computers. Many users desire to coordinate or synchronize the data between their portable devices, their home devices, and their business or office devices. Synchronization programs, for example, allow a user to interface two devices, such as a portable computer and a desktop computer, and essentially merge desired data to provide both devices with an updated data record. The programs usually can scan a desired database on one device, such as the portable computer, and compare the desired database with a similar database on the desktop computer for new or updated data not contained on the desktop computer. In this manner, new or updated data, such as customer information, personal phone numbers, documents, etc., in a database on the portable computer can be transferred to the home computer to update the data record on the home computer. The procedure can also be performed substantially simultaneously in reverse to transfer new or updated data from the desktop computer to the portable computer. As a result, each device has identical copies of the updated data record so the user has access to the latest data regardless of which device is being used.

In an office environment, for example, synchronization can often be critical to increasing productivity and versatility because it permits several users to share important data. As discussed above, this is generally accomplished by networking individual computer stations together to share data. However, networks are sometimes undesirable for security reasons, for cost reasons, or for environmental reasons. Therefore, an external and portable data transfer and storage device is desirable to enable sharing and updating of data on multiple computers or other devices without the use of a network.

U.S. Pat. No. 5,758,067 describes a system and a method for automatically archiving data from a computer system to a backup system. The disadvantage of this is that the backup procedure is controlled by a software menu which must be correspondingly scheduled by the user. The start of the archiving is initiated at a previously entered time and can only be varied as part of the setting [procedure]. Furthermore, no data of a more recent date can be transferred from the backup system to the computer system.

WO 01/27768 discloses a method for an automatic backup of a computer with a peripheral hard drive, the hard drive being connected via the PCMCIA port of the computer. In this case the CPU of the computer detects the connection with the external hard drive and automatically starts a backup procedure to the external hard drive. The disadvantage of this is that it merely stores the computer's data on the external hard drive. Data of a more recent date on the external hard drive are not transferred to the computer so that merely the current data inventory on the computer is backed up to the external hard drive. The backup is automatically started when the connection at the port is established without the user being able to start the process him/herself.

U.S. Pat. No. 5,887,145 describes a method of reading out memory cards in a host system. In this case, a connection with the host system is established by what is called a mother card. The data to be read out is stored on a daughter card, which can be connected to the mother card. The mother card is connected to the host system via an interface and the daughter card can be connected to the mother card via a second interface. The daughter card can be provided by Flash EEPROM Chips, hard drives, or other peripherals. But the disadvantage here is that, when the daughter card is connected by a plug-in connection to the mother card, a data transfer is automatically initiated. The user can only decide the time of the data transfer by deciding the time at which the mother card and daughter card are to be connected.

### OBJECT OR OBJECTS

Taking the prior art as its point of departure, one object of the present application is to create a facility for a computer system which features integrated data storage between several independent computer systems and interface technologies and which can be simply operated by the user.

Another possible object is to provide a system to synchronize and transfer data using an external drive or device that can be connected to different computers to permit transfer of data.

### SUMMARY

The objects can possibly be achieved by a procedure for monitoring and exchanging data between an external data storage unit and at least one stationary computer unit, the stationary computer unit being connected via at least one port and one data connection to the external data storage unit, and an operating program on the stationary computer unit continuously monitoring existing ports for a data connection to an external data storage unit, characterized in that, in case of an existing data connection via a port, the operating program detects the generation of a voltage pulse by a pulse generator connected to the data connection and located on the external data storage unit and subsequently initiates further processes on the stationary computer unit and the external data storage unit. According to this, this embodiment of the invention is characterized by the fact that, when there is an existing data connection via a port, the operating program detects the generation of a voltage pulse by a pulse generator connected to the data connection and located on the external data storage unit, and, subsequently, initiates further processes on the stationary computer unit and the external data storage unit. If a voltage pulse is detected by the operating program, a data exchange via the existing data connection between the data storage unit and the stationary computer unit is also initiated.

In other words and in accordance with one possible embodiment, the operating program is designed to monitor the port to which the external data storage unit can be connected. Once the operating program detects that the external data storage unit is connected to the stationary computer, the operating program then begins monitoring the external data storage unit for a voltage pulse that is stored in the external data storage unit as a command in the memory. The operating program thus controls the data exchange between the external data storage unit and the stationary computer unit by only initiating a data exchange or transfer upon detection of a voltage pulse. The operating program can essentially continuously monitor the port and the external data storage unit, even while other programs are running on the stationary computer. In this manner, a user does not have to operate a complicated program to initiate a data synchronization. The user simply connects the external data storage unit to the computer, and then actuates the voltage pulse generator on the external data storage unit, such as by pressing a button on the external data storage unit. The operating program then handles the data synchronization or transfer. However, the user still is in control of the data exchange because the data exchange does not begin until the user has actuated the voltage pulse generator. Until such time, the external data storage unit can be connected to the stationary computer without a data exchange occurring. This provides the user with the flexibility of determining when the data exchange will take place.

The purpose of a possible embodiment of the invention is therefore also to create an appropriate operating program to execute such a procedure.

The term data exchange as used in this application means any mutual exchange in the form of electronic or electrical information between a computer unit and a peripheral connected to the computer unit.

The data are preferably transferred in data packets.

Furthermore, the operating program can control the data exchange in a manner permitting a data exchange and, simultaneously, the recognition of an additionally triggered voltage pulse by the pulse generator, the detection of the voltage pulse being executed by the operating program between the sequentially transferred data packets. The data exchange triggered by the detection of the voltage pulse initiates a data synchronization of a pre-defined hard drive memory area on the stationary computer unit and the external data storage unit. After completion of the data synchronization between the stationary computer unit and the external data storage unit, the data connection can be interrupted and the external data storage unit can be used for data synchronization with a second stationary computer unit. A repeat data exchange is also possible with the original computer unit.

In other words, the operating program can monitor the external data storage unit for voltage pulses even during a data exchange. The monitoring check is performed in between the transfer of individual packets of data. In addition, after the data exchange is complete, the external data storage unit can be disconnected from the stationary computer and then connected to a second stationary computer. Another data exchange can be performed with the second stationary computer, thus updating the second stationary computer with any new or updated data from the first stationary computer. In addition, new or updated data could be retrieved from the second stationary computer and stored on the external data storage unit. After the second data exchange is complete, any number of subsequent data exchanges could be performed with other stationary computer units to retrieve new or updated data from these stationary computer units, as well as add new or updated data to these stationary computer units. A user could then return to the first stationary computer unit and perform the data exchange again. As a result, all of the new or updated data obtained from the other stationary computer units would be added to the first stationary computer unit. The data exchanges could be repeated as many times as is necessary until all of the stationary computer units contain the same data record.

The pulse generator is accessed by the operating program of the stationary computer unit as a virtual drive, the virtual drive not being used as a traditional drive, but selected communication commands to control the virtual drive are transformed by the operating program automatically for the purpose of monitoring a voltage pulse generated at the pulse generator, the pulse generator being accessible as a virtual drive only by the operating program and is not integrated into the data storage administration of the stationary computer unit. This ensures a secured execution of the operating program independent of the operating system and the monitoring of the external data storage unit and the external pulse generator can be arranged independent of the interface. The operating program is interposed into the data storage communication between the computer unit and the external data storage unit and permits the external data storage unit to be directly accessed as an additional drive. The control and monitoring of the pulse generator as a virtual drive is, on the other hand, not integrated into the data storage communication of the stationary computer unit, but is controlled and administered by the operating program. Hence, for example on a Windows application, the external data storage unit is visible and available for use as an additional drive. However, the pulse generator as a virtual drive is not visible and directly available to the user as a drive. A use as pulse generator is only possible through the operating program on the stationary computer unit, the communication commands to control the virtual drive being automatically transformed into directions for the recognition of a voltage pulse at the pulse generator.

To further explain, in one possible embodiment the voltage pulses generated by the voltage pulse generator in the external data storage unit can be accessed by the operating program in a virtual drive or virtual memory. The virtual drive can be a partition or section of memory separate from the main drive in the external data storage unit that is essentially inaccessible to the user. The virtual drive is only accessible to and controlled by the operating program to detect voltage pulses. In this manner, the operating program and pulse generator can operate separately from the main drive in the external data storage unit and the operating system of the stationary computer.

The external data storage unit is also integrated as an additional data storage drive into the data storage administration of the stationary computer unit, and can be accessed as an independent drive from the stationary computer unit. This provides the opportunity to assign the external data storage unit as an additional drive to the stationary computer unit, the monitoring of the pulse generator by the operating program on the stationary computer unit being simultaneously ensured. This form as integrated drive of the external data storage unit into the stationary computer unit has proven itself to be advantageous, since this ensures an interface and computer independent execution of the operating program.

To further explain, in one possible embodiment the external data storage unit contains an external hard drive. This external hard drive, when connected to a stationary computer, can be utilized by the stationary computer as an additional drive to supplement the main hard drive contained in the stationary computer itself. In this manner, the external data storage unit can be utilized not only to exchange and transfer data, but also as an additional drive to further enhance the capabilities and use of the stationary computer.

Moreover, in the external data storage unit an integrated pulse generator is mounted on the outside of the data storage unit, this being preferably a push button assembly. In addition, one possible embodiment provides for the use of other pulse generators, such as contact sensors, switches, or control switches of all kinds. It is also possible for the pulse to be triggered by a touch screen or similar display systems. The data connection is ensured by a data transfer cable, the operating program monitoring the port for a data connection and, in case of a data connection, with the external data storage unit, monitoring the pulse generator via the data transfer cable. In the case of a detected voltage pulse by the pulse generator, the operating program initiates a data exchange via the existing data connection between the data storage unit and the stationary computer unit. Optionally, the voltage pulse generated by the pulse generator in this context can be temporarily stored as a change in a memory log in the data storage unit, and be read out by the operating program at a later point in time via the existing data connection. The memory log is re-initialized at the time of the readout. The readout of the memory log by the operating program is performed especially between the two sequentially transferred data packets. A repeat voltage pulse can thus be temporarily stored in the memory log.

In one possible embodiment, a user can press the button on the external data storage unit during a data exchange. This push of the button will generate a voltage pulse which is indicated to the operating program by a change in the memory log of the virtual drive. The operating program, as discussed above, could detect this change in the memory log by checking the memory log in between the transfer of two individual data packets during the data exchange procedure. The detection of the change in memory log, i.e. the voltage pulse, could result in different desired functions. For example, one function could be the restarting of the data synchronization. Another possible function could be the pausing or stopping of the data exchange. Other computer functions could be executed by the operating program that are not specifically set forth herein but are conceivable within the scope of the application.

Moreover, if a voltage pulse is detected at the pulse generator, it is possible for the operating program to initiate a data synchronization of a pre-defined hard drive area on the stationary computer unit and the external data storage unit connected via the data transfer cable. After the data synchronization is completed between the stationary computer unit and the external data storage unit, the data connection can be interrupted. The external data storage unit is then connected to another stationary computer unit and the currently stored data on the external storage unit used for data synchronization with another computer unit. The external data storage unit can also be connected again to the original stationary computer.

It is preferable that the data exchange is optionally monitored by optical auxiliary means configured on the external data storage unit, especially LEDs, which are activated in the event of a data transfer. For this purpose different connection technologies (USB, FireWire, CardBus, PC Card, etc.) can be used for the data connection and by the operating program.

Further advantageous measures are described herein below. Possible embodiments of the invention are described using sample embodiments in the following sections.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows a schematic drawing of the data connection between a stationary computer unit and the external data storage unit according to a possible embodiment the invention;

FIG. 1A shows a view of the data connector cable and port on the stationary computer;

FIG. 1B shows a diagrammatic view of the external data storage unit; and

FIG. 2 is a flow chart showing steps in a data exchange process according to one possible embodiment.

### DESCRIPTION OF EMBODIMENT OR EMBODIMENTS

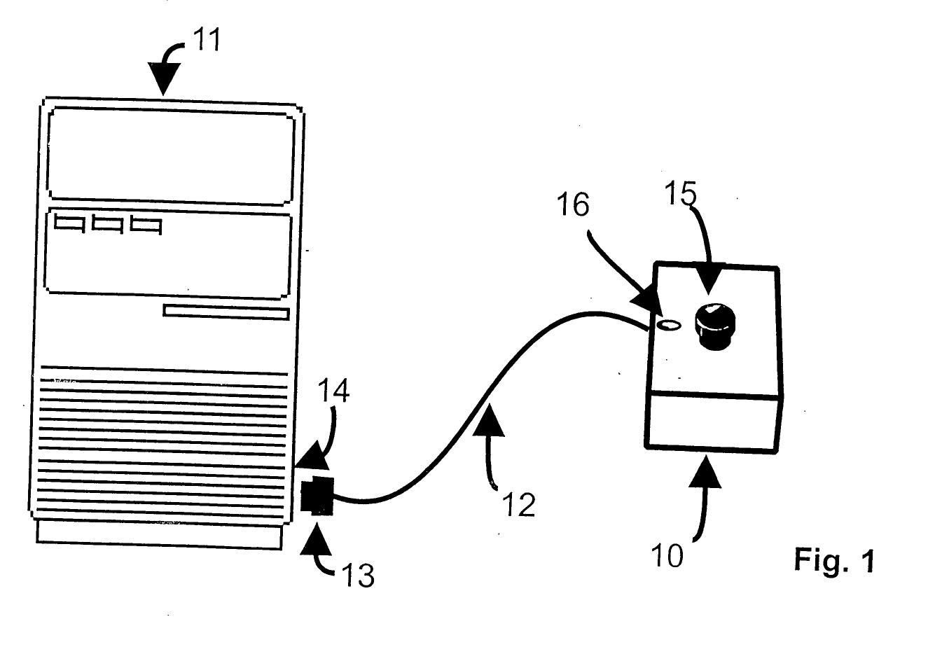

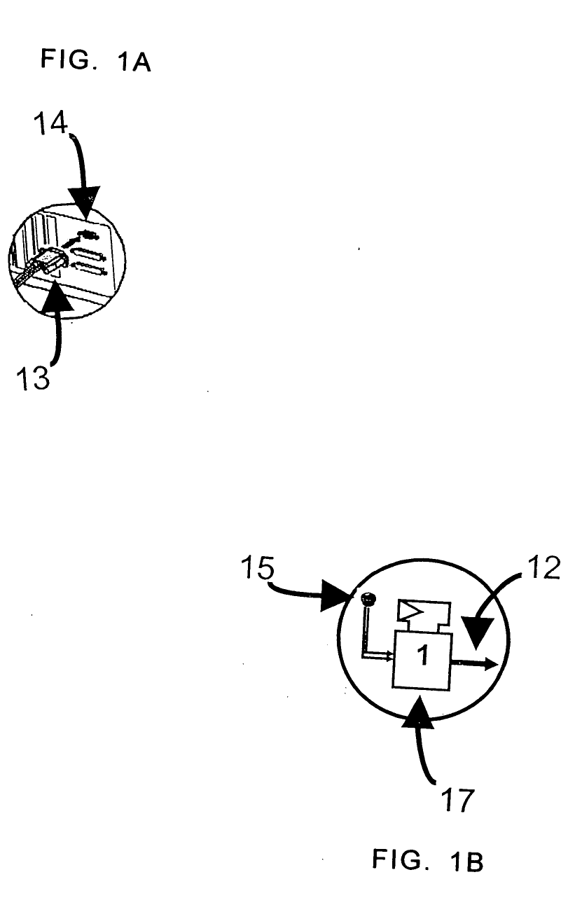

FIG. 1 shows a schematic drawing of the data connection between a stationary computer unit 11 and the external data storage unit 10 according to one possible embodiment. The data connection is ensured by a port 14 of the stationary computer unit 11 and a plug-in data transfer cable 12,13 (see FIG. 1A). An operating program in the stationary computer unit 11 continuously monitors the port 14 for a possible data connection. As can be seen in FIG. 1B, In case of an existing data connection with the data storage unit 10, the operating program monitors, via the data line 12,13, the push button assembly 15 integrated in the data storage unit to the end that, by pressing the push button assembly 15, a voltage pulse is generated. In the process the voltage pulse can be stored temporarily in the form of a change in memory log 17. Then, via data line 12, the status of memory log 17 can be queried by the operating program. If a voltage pulse is temporarily stored in the memory log 17, the operating program detects this change in memory log 17 when it accesses the memory log 17 via the data line 12,13, and re-initializes memory log 17. With the readout of the altered memory log 17 via the data line 12,13, the operating program starts additional processes in the stationary computer 11. In particular a data synchronization of a pre-defined hard drive area on the stationary computer unit 11 and the external data storage unit 10 is provided for here. The operating program in the stationary computer unit 11 then controls the data exchange in such a way that between the sequentially transferred data packets via the existing data line 12,13 a repeat pressing of the push button assembly 15 by the readout of a repeat change in the memory log 17 can be detected. The data exchange can be monitored with the help of an appropriately activated LED 16. If the push button assembly 14 is pressed again, the operating program of computer unit 11 starts further processes such as an interruption of the data synchronization or an initialization of the operating program.

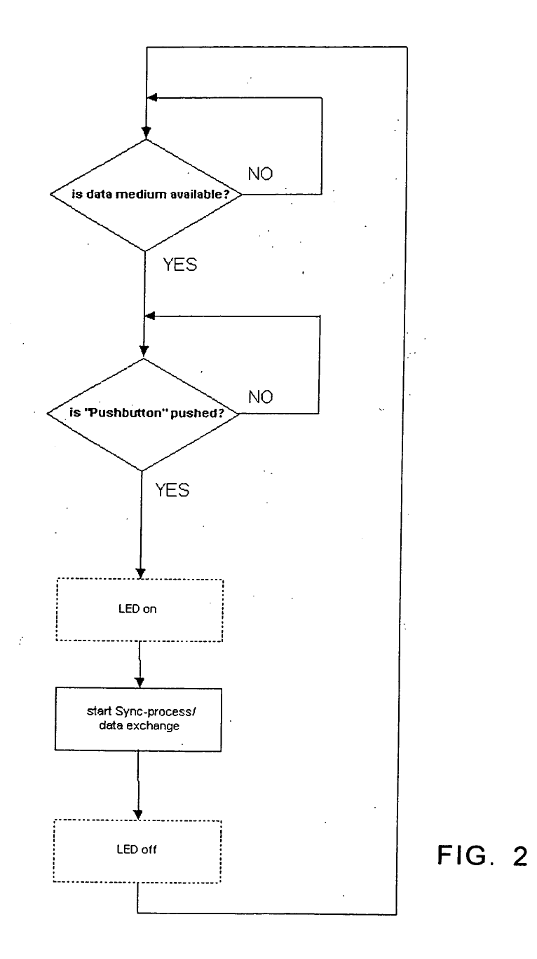

FIG. 2 is a flow chart showing steps in a data exchange process according to one possible embodiment. The flow chart shows the first step as being the operating program checking for a data connection at the computer port 14 by the question “is data medium available?”. If the answer is “no,” meaning there is no cable 13 connected to the port 14, the operating program continues to ask the question until the answer is “yes,” meaning the operating program has detected the cable 13 connected to the port 14. After the operating program affirms that a connection is established, the program starts to monitor the memory log 17 in the virtual drive for the pulse generator to detect voltage pulses as a result of the pushbutton being pushed, which step is represented by the question “is ‘Pushbutton’ pushed?”. Similar to the step of detecting a data cable connection, the operating program continues to query the memory log 17 over and over again until the program detects a voltage pulse indicator, i.e. a “yes” answer. In addition, the operating program still monitors the port 14 substantially simultaneously to affirm that the data cable 13 is still connected. If the data cable 13 is disconnected, the operating program will receive a “no” answer to the initial query “is data medium available?”, and will thus return to the cycle of only monitoring for a data cable connection rather than checking for a voltage pulse.

Upon the answer being “yes” for the question “is ‘Pushbutton’ pushed?”, in this embodiment, an indicator in the form of an LED light is activated to provide the user with visual indication that a data transfer procedure is being performed. Substantially simultaneously, the operating program begins the data synchronization or data exchange process. Upon completion and/or stoppage of the data exchange process, the LED light will no longer be activated, thus providing the user with visual indication that the data exchange process has been terminated. In alternative embodiment, the LED light could be replaced by other visual-type status indicators or audio-type status indicators, or no status indicator could be used at all.

One feature or aspect of an embodiment is believed at the time of the filing of this patent application to possibly reside broadly in a procedure for monitoring and exchanging data between an external data storage unit and at least one stationary computer unit, the stationary computer unit being connected via at least one port and one data connection to the external data storage unit, and an operating program on the stationary computer unit continuously monitoring existing ports for a data connection to an external data storage unit, characterized in that, in case of an existing data connection via a port, the operating program detects the generation of a voltage pulse by a pulse generator connected to the data connection and located on the external data storage unit and subsequently initiates further processes on the stationary computer unit and the external data storage unit.

Another feature or aspect of an embodiment is believed at the time of the filing of this patent application to possibly reside broadly in the procedure, characterized in that, in case of the detection of a voltage pulse by the operating program, a data exchange is initiated via the existing data connection between the data storage unit and the stationary computer unit.

Yet another feature or aspect of an embodiment is believed at the time of the filing of this patent application to possibly reside broadly in the procedure, characterized in that the data are transferred via the data connection as data packets.

Still another feature or aspect of an embodiment is believed at the time of the filing of this patent application to possibly reside broadly in the procedure, characterized in that the operating program controls the data exchange in such a way that, via an existing data connection, simultaneously a data exchange and the recognition of a repeat triggered voltage pulse by the pulse generator is possible, the detection of the voltage pulse by the operating program being executed between the sequentially transferred data packets.

A further feature or aspect of an embodiment is believed at the time of the filing of this patent application to possibly reside broadly in the procedure, characterized in that the data exchange triggered by the detection of the voltage pulse initiates a data synchronization of a pre-defined hard drive area between the stationary computer unit and the external data storage unit.

Another feature or aspect of an embodiment is believed at the time of the filing of this patent application to possibly reside broadly in the procedure, characterized in that the pulse generator is accessed by the operating program in the stationary computer unit as a virtual drive, the virtual drive not being used as a traditional drive, but selected communication commands for the control of the virtual drive by the operating program are automatically transformed for monitoring a voltage pulse triggered at the pulse generator. The pulse generator is accessible as a virtual drive only by the operating program and is not integrated into the data storage administration of the stationary computer unit.

Yet another feature or aspect of an embodiment is believed at the time of the filing of this patent application to possibly reside broadly in the procedure, characterized in that the external data storage unit is integrated as an additional data storage drive into the data storage administration of the stationary computer unit and can be accessed as an independent drive from the stationary computer unit.

Still another feature or aspect of an embodiment is believed at the time of the filing of this patent application to possibly reside broadly in the procedure, characterized in that the pulse generator integrated in the external data storage unit is mounted on the outside of the data storage unit, and is especially a push button.

A further feature or aspect of an embodiment is believed at the time of the filing of this patent application to possibly reside broadly in the procedure, characterized in that different connection technologies are used via the port for the data connection and are utilized by the operating program in the stationary computer unit.

Another feature or aspect of an embodiment is believed at the time of the filing of this patent application to possibly reside broadly in the procedure, characterized in that, in case of a data exchange, an optical auxiliary means built into the external data storage unit, especially LEDs, is activated by the data transfer.

Yet another feature or aspect of an embodiment is believed at the time of the filing of this patent application to possibly reside broadly in the process, characterized in that the voltage pulse generated by the pulse generator is temporarily stored as a change in a memory log in the data storage unit and is read out at a later point in time by the operating program via the existing data connection, with the memory log being newly initialized with the read out.

Another feature or aspect of an embodiment is believed at the time of the filing of this patent application to possibly reside broadly in an operating program to execute the procedure described above.

The components disclosed in the various publications, disclosed or incorporated by reference herein, may possibly be used in possible embodiments of the present invention, as well as equivalents thereof.

This application relates, in at least one possible embodiment, to a procedure for operating an external data storage unit comprising at least one stationary computer unit and one external data storage unit connectable to the computer unit via a port and a data connection. In the stationary computer unit, an operating program substantially continuously monitors possible ports for a data connection with an external data storage unit and, simultaneously, in case of a data connection via a port with an external data storage unit, monitors whether a pulse generator on the external data storage unit connected to the data connection has generated a voltage pulse. After the detection further processes can be started by the operating program, especially for data synchronization. The pulse generator located on the external data storage unit for generating the voltage pulse is preferably a push button assembly.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Some examples of methods and/or devices relating to external hard drives or external hard disks that may possibly be utilized or adapted for use in at least one possible embodiment may possibly be found in the following patent publications: U.S. Pat. No. 6,639,791, entitled “Portable external hard drive”; U.S. Pat. No. 6,681,269, issued on Jan. 20, 2004 to Hirabayashi, et al.; U.S. Pat. No. 5,796,965 issued on Aug. 18, 1998 to Choi, et al.; U.S. Pat. No. 4,490,784 issued December 1984 to Ives et al.; U.S. Pat. No. 4,683,530 issued July 1987 to Quatse; U.S. Pat. No. 5,202,884 issued April 1993 to Close et al.; U.S. Pat. No. 5,390,350 issued February 1995 to Chung et al.; U.S. Pat. No. 5,408,678 issued April 1995 to Kato et al.; U.S. Pat. No. 5,418,785 issued May 1995 to Olshansky et al.; U.S. Pat. No. 5,430,684 issued July 1995 to Kim et al.; U.S. Pat. No. 5,442,472 issued August 1995 to Skrobko; U.S. Pat. No. 5,497,362 issued March 1996 to Aizawa; U.S. Pat. No. 5,627,730 issued May 1997 to Konig et al.; U.S. Pat. No. 5,680,443 issued October 1997 to Kasday et al.; U.S. Pat. No. 5,790,786 issued August 1998 to Wakeman et al.; U.S. Pat. No. 5,822,508 issued October 1998 to Ohara; U.S. Pat. No. 5,847,741 issued December 1998 to Lee; U.S. Pat. No. 5,961,624 issued October 1999 to Takayama; U.S. Pat. No. 6,219,695 issued April 2001 to Guttag et al.; EP 0 589 499 published March 1994; JP 02132514 published May 1990; JP 05173907 published July 1993; JP 07302176 published November 1995; JP 09055737 published February 1997; WO 96 37851 published November 1996; U.S. Pat. No. 6,549,490 issued Apr. 15, 2003 to Howarth; U.S. Pat. No. 5,859,968 issued January 1999 to Brown et al.; U.S. Pat. No. 5,862,113 issued January 1999 to Tsuyuguchi et al.; U.S. Pat. No. 5,870,355 issued February 1999 to Fujihara; U.S. Pat. No. 5,894,579 issued April 1999 to Fujihara; U.S. Pat. No. 6,173,430 issued January 2001 to Massoudi; U.S. Pat. No. 6,317,836 issued November 2001 to Goren et al.; U.S. Pat. No. 5,499,384 entitled “Input output control unit having dedicated paths for controlling the input and output of data between host processor and external device”; U.S. Pat. No. 5,497,491 entitled “System and method for importing and exporting data between an object oriented computing environment and an external computing environment”; U.S. Pat. No. 5,497,482 entitled “Data processor in which external sync signal may be selectively inhibited”; U.S. Pat. No. 5,493,686 entitled “Data processor in which external sync signal may be selectively inhibited”; U.S. Pat. No. 5,455,925 entitled “Data processing device for maintaining coherency of data stored in main memory, external cache memory and internal cache memory”; US entitled “Data processing system with interface between application programs and external tools residing in separate environments”; U.S. Pat. No. 5,440,754 entitled “Work station and method for transferring data between an external bus and a memory unit”; U.S. Pat. No. 5,390,328 entitled “Data processing system and method for providing notification in a central processor of state changes for shared data structure on external storage”; U.S. Pat. No. 5,386,548 entitled “Method for storing data from an external processor in storage devices through buffer devices”; U.S. Pat. No. 5,335,327 entitled “External memory control techniques with multiprocessors improving the throughput of data between a hierarchically upper processing unit and an external memory with efficient use of a cache memory”; and U.S. Pat. No. 5,257,388 entitled “Device for detecting whether an attached external memory stores valid data, if not, whether the external memory is capable of storing data.”

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

Some examples of methods and/or devices relating to memory cards and memory chips that may possibly be utilized or adapted for use in at least one possible embodiment may possibly be found in the following patent publications: U.S. Pat. No. 5,579,502 issued Nov. 26, 1996 to Konishi, et al.; U.S. Pat. No. 4,758,883 issued July 1988 to Kawahara et al.; U.S. Pat. No. 4,803,554 issued February 1989 to Pape; U.S. Pat. No. 5,093,731 issued March 1992 to Watanabe et al.; U.S. Pat. No. 5,153,730 issued October 1992 to Nagasaki et al.; U.S. Pat. No. 5,303,198 issued April 1994 to Adachi et al.; EP 0366474 published May 1990; EP 0372514 published June 1990; JP 2-222280 published February 1990; U.S. Pat. No. 6,678,790 entitled “Microprocessor chip having a memory that is reconfigurable to function as on-chip main memory or an on-chip cache”; U.S. Pat. No. 6,671,837 entitled “Device and method to test on-chip memory in a production environment”; U.S. Pat. No. 6,658,516 entitled “Multi-interface memory card and adapter module for the same”; U.S. Pat. No. 6,647,496 entitled “Semiconductor memory card”; U.S. Pat. No. 6,643,725 entitled “Memory card having a buffer memory for storing testing”; U.S. Pat. No. 6,636,773 entitled “Semiconductor memory card, apparatus for recording data onto the semiconductor memory card, and apparatus for reproducing data of the semiconductor memory card”; U.S. Pat. No. 6,633,956 entitled “Memory card with task registers storing physical addresses”; U.S. Pat. No. 6,625,692 entitled “Integrated semiconductor memory chip with presence detect data capability”; U.S. Pat. No. 6,623,304 entitled “Connector for flash memory card, connection structure using connector and electronic apparatus using connection structure”; U.S. Pat. No. 6,618,791 entitled “System and method for controlling power states of a memory device via detection of a chip select signal”; U.S. Pat. No. 6,618,789 entitled “Security memory card compatible with secure and non-secure data processing ”; U.S. Pat. No. 6,618,784 entitled “Universal memory bus and card”; U.S. Pat. No. 6,618,258 entitled “Portable memory card system”; U.S. Pat. No. 6,612,492 entitled “Four-in-one memory card insertion port”; U.S. Pat. No. 6,611,907 entitled “Semiconductor memory card access apparatus, a computer-readable recording medium, an initialization method, and a semiconductor memory card”; U.S. Pat. No. 6,609,236 entitled “Semiconductor IC device having a memory and a logic circuit implemented with a single chip”; U.S. Pat. No. 6,606,707 entitled “Semiconductor memory card”; U.S. Pat. No. 6,594,738 entitled “Semiconductor device in which MPU and DRAM as secondary cache memory are mounted on same chip to easily realize high speed of cycle time under restriction on chip ”; U.S. Pat. No. 6,585,164 entitled “Asynchronous memory card”; U.S. Pat. No. 6,549,460 entitled “Memory device and memory card”; U.S. Pat. No. 6,536,004 entitled “On-chip circuit and method for testing memory devices”; U.S. Pat. No. 6,522,577 entitled “System and method for enabling chip level erasing and writing for magnetic random access memory devices”; U.S. Pat. No. 6,501,163 entitled “Semiconductor memory card”; U.S. Pat. No. 6,493,033 entitled “Electronic apparatus adapted to receive a memory card”; U.S. Pat. No. 6,480,014 entitled “High density, high frequency memory chip modules having thermal management structures”; U.S. Pat. No. 6,477,671 entitled “Semiconductor memory, memory device, and memory card”; U.S. Pat. No. 6,467,690 entitled “Electronic storage memory card or disk and laser reader/writer interface”; and U.S. Pat. No. 6,467,016 entitled “Apparatus to record digital data on non-volatile memory card for recording in units of blocks of digital data and method thereof.”

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Sep. 1, 2003, and/or cited elsewhere are hereby incorporated by reference as if set forth in their entirety herein as follows: WO 01 27768 A to Robinson, published Apr. 19, 2001; and U.S. Pat. No. 5,758,067 A to Makinen et al., published May 26, 1998.

Some examples of methods and/or devices relating to data storage and data backup for computers that may possibly be utilized or adapted for use in at least one possible embodiment may possibly be found in the following patent publications: U.S. Pat. No. 6,684,229 issued Jan. 27, 2004 to Luong, et al.; U.S. Pat. No. 6,240,527 issued May 29, 2001 to Schneider, et al.; U.S. Pat. No. 5,079,740 issued January 1992 to Patel et al.; U.S. Pat. No. 5,269,022 issued December 1993 to Shinjo et al.; U.S. Pat. No. 5,469,573 issued November 1995 to McGill, III et al.; U.S. Pat. No. 5,638,509 issued June 1997 to Dunphy et al.; U.S. Pat. No. 5,694,600 issued December 1997 to Khenson et al.; U.S. Pat. No. 5,708,776 issued January 1998 to Kikinis; U.S. Pat. No. 5,713,024 issued January 1998 to Halladay; U.S. Pat. No. 5,754,782 issued May 1998 to Masada; U.S. Pat. No. 5,761,677 issued June 1998 to Senator et al.; U.S. Pat. No. 5,873,101 issued February 1999 to Klein; U.S. Pat. No. 5,884,324 issued March 1999 to Cheng et al.; U.S. Pat. No. 6,205,527 issued March 2001 to Goshey et al.; U.S. Pat. No. 6,324,654 issued November 2001 to Wahl et al.; U.S. Pat. No. 6,446,090 issued September 2002 to Hart; U.S. Pat. No. 6,477,629 issued November 2002 to Goshey et al.; U.S. Pat. No. 5,089,958 issued February 1992 to Horton et al.; U.S. Pat. No. 5,297,258 issued March 1994 to Hale et al.; U.S. Pat. No. 5,325,519 issued June 1994 to Long et al.; U.S. Pat. No. 5,331,646 issued July 1994 to Krueger et al.; U.S. Pat. No. 5,339,406 issued August 1994 to Carney et al.; U.S. Pat. No. 5,381,545 issued January 1995 to Baker et al.; U.S. Pat. No. 5,404,361 issued April 1995 to Casorso et al.; U.S. Pat. No. 5,487,160 issued January 1996 to Bemis; U.S. Pat. No. 5,524,205 issued June 1996 to Lomet et al.; U.S. Pat. No. 5,557,770 issued September 1996 to Bhide et al.; U.S. Pat. No. 5,598,528 issued January 1997 to Larson et al.; U.S. Pat. No. 5,604,853 issued February 1997 to Nagashima; U.S. Pat. No. 5,604,862 issued February 1997 to Midgely et al.; U.S. Pat. No. 5,640,561 issued June 1997 to Satoh et al.; U.S. Pat. No. 5,659,747 issued August 1997 to Nakajima; U.S. Pat. No. 5,751,936 issued May 1998 to Larson et al.; U.S. Pat. No. 5,802,264 issued September 1998 to Chen et al.; and U.S. Pat. No. 5,835,953 issued November 1998 to Ohran.

The corresponding foreign and international patent publication applications, namely, Federal Republic of Germany Patent Application No. 102 09 712.7, filed on Mar. 6, 2002, having inventors Pieter BOTS, Carsten RUSS, Axel LUCASSEN, and Herman PERK, and DE-OS 102 09 712.7 and DE-PS 102 09 712.7, and International Application No. PCT/DE03/00746, filed on Mar. 4, 2003, having inventors Pieter BOTS, Carsten RUSS, Axel LUCASSEN, and Herman PERK, as well as their published equivalents, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

Some examples of methods and/or devices relating to data synchronization that may possibly be utilized or adapted for use in at least one possible embodiment may possibly be found in the following patent publications: U.S. Pat. No. 6,671,700 entitled “Method and apparatus for parallel execution of conduits during simultaneous synchronization of databases”; U.S. Pat. No. 5,574,859 issued November 1996 to Yeh; U.S. Pat. No. 5,666,530 issued September 1997 to Clark et al.; U.S. Pat. No. 5,713,045 issued January 1998 to Berdahl; U.S. Pat. No. 5,734,886 issued March 1998 to Grosse et al.; U.S. Pat. No. 5,884,323 issued March 1999 to Hawkins et al.; U.S. Pat. No. 5,928,329 issued July 1999 to Clark et al.; U.S. Pat. No. 6,000,000 issued December 1999 to Hawkins et al.; U.S. Pat. No. 6,006,105 issued December 1999 to Rostoker et al.; U.S. Pat. No. 6,035,212 issued March 2000 to Rostoker et al.; U.S. Pat. No. 6,125,369 issued September 2000 to Wu et al.; U.S. Pat. No. 6,157,935 issued December 2000 to Tran et al.; U.S. Pat. No. 6,295,541 issued September 2001 to Bodnar et al.; U.S. Pat. No. 6,401,104 issued June 2002 to LaRue et al.; U.S. Pat. No. 6,438,515 issued August 2002 to Crawford et al.; and U.S. Pat. No. 6,477,543 issued November 2002 to Huang et al.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

Some examples of data synchronization programs that may possibly be utilized or adapted for use in at least one possible embodiment are as follows: Intellisync Data Synchronization by Intellisync Corporation, 2550 North First Street, Suite #500, San Jose, Calif. 95131; FusionOne by FusionOne, 1 Alamaden Blvd., 11th Floor, San Jose, Calif. 95113; Pervasive DataExchange by Pervasive Software, 12365 Riata Trace Parkway, Bldg. B, Austin, Tex. 78727; CompanionLink by CompanionLink Software, Inc., 15858 SW Upper Boones Ferry Road, Lake Oswego, Oreg. 97035; DATA SYNC MANAGER by Global eXchange Services (GXS), 100 Edison Park Drive, Gaithersburg, Md. 20878; ViceVersa by TGRMN software; Advanced Directory Comparison And Synchronization by Heatsoft Corporation, 4160 So. Pecos Road Suite #20, Las Vegas, Nev. 89121; and PeerSync and Save-N-Sync by PEER SOFTWARE, INC., 1363-26 Veterans Highway, Hauppauge, N.Y. 11788-3046.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### At Least Partial List of Drawing References

10 External data storage unit

11 Stationary computer unit

12 Data transfer cable

13 Plug-in connector

14 Port

15 Pulse generator

16 LED

17 Memory log

1. Procedure for monitoring and exchanging data between an external data storage unit and at least one stationary computer unit, the stationary computer unit being connected via at least one port and one data connection to the external data storage unit, and an operating program on the stationary computer unit continuously monitoring existing ports for a data connection to an external data storage unit, characterized in that, in case of an existing data connection via a port (12,13,14), the operating program detects the generation of a voltage pulse by a pulse generator (15) connected to the data connection (12,13,14) and located on the external data storage unit (10) and subsequently initiates further processes on the stationary computer unit (11) and the external data storage unit (10).

2. Procedure according to claim 1, characterized in that, in case of the detection of a voltage pulse by the operating program, a data exchange is initiated via the existing data connection (12,13,14) between the data storage unit (10) and the stationary computer unit (11).

3. Procedure according to claim 2, characterized in that the data are transferred via the data connection (12,13,14) as data packets.

4. Procedure according to claim 3, characterized in that the operating program controls the data exchange in such a way that, via an existing data connection (12,13,14), simultaneously a data exchange and the recognition of a repeat triggered voltage pulse by the pulse generator (15) is possible, the detection of the voltage pulse by the operating program being executed between the sequentially transferred data packets.

5. Procedure according to claim 4, characterized in that the data exchange triggered by the detection of the voltage pulse initiates a data synchronization of a pre-defined hard drive area between the stationary computer unit (11) and the external data storage unit (10).

6. Procedure according to claim 5, characterized in that the pulse generator (15) is accessed by the operating program in the stationary computer unit (11) as a virtual drive, the virtual drive not being used as a traditional drive, but selected communication commands for the control of the virtual drive by the operating program are automatically transformed for monitoring a voltage pulse triggered at the pulse generator (15). The pulse generator (15) is accessible as a virtual drive only by the operating program and is not integrated into the data storage administration of the stationary computer unit (11).

7. Procedure according to claim 6, characterized in that the external data storage unit (10) is integrated as an additional data storage drive into the data storage administration of the stationary computer unit (11) and can be accessed as an independent drive from the stationary computer unit (11).

8. Procedure according to claim 7, characterized in that the pulse generator (15) integrated in the external data storage unit (10) is mounted on the outside of the data storage unit (10), and is especially a push button.

9. Procedure according to claim 8, characterized in that different connection technologies are used via the port (14) for the data connection and are utilized by the operating program in the stationary computer unit (11).

10. Procedure according to claim 9, characterized in that, in case of a data exchange, an optical auxiliary means (16) built into the external data storage unit (10), especially LEDs, is activated by the data transfer.

11. Procedure according to claim 10, characterized in that the voltage pulse generated by the pulse generator (15) is temporarily stored as a change in a memory log (17) in the data storage unit (10) and is read out at a later point in time by the operating program via the existing data connection (12,13,14), with the memory log (17) being newly initialized with the read out.

12. Operating program to execute the procedure according to claim 1.

13. Procedure according to claim 2, characterized in that the operating program controls the data exchange in such a way that, via an existing data connection (12,13,14), simultaneously a data exchange and the recognition of a repeat triggered voltage pulse by the pulse generator (15) is possible, the detection of the voltage pulse by the operating program being executed between the sequentially transferred data packets.

14. Procedure according to claim 2, characterized in that the data exchange triggered by the detection of the voltage pulse initiates a data synchronization of a pre-defined hard drive area between the stationary computer unit (11) and the external data storage unit (10).

15. Procedure according to claim 1, characterized in that the pulse generator (15) is accessed by the operating program in the stationary computer unit (11) as a virtual drive, the virtual drive not being used as a traditional drive, but selected communication commands for the control of the virtual drive by the operating program are automatically transformed for monitoring a voltage pulse triggered at the pulse generator (15). The pulse generator (15) is accessible as a virtual drive only by the operating program and is not integrated into the data storage administration of the stationary computer unit (11).

16. Procedure according to claim 15, characterized in that the external data storage unit (10) is integrated as an additional data storage drive into the data storage administration of the stationary computer unit (11) and can be accessed as an independent drive from the stationary computer unit (11).

17. Procedure according to claim 1, characterized in that the pulse generator (15) integrated in the external data storage unit (10) is mounted on the outside of the data storage unit (10), and is especially a push button.

18. Procedure according to claim 1, characterized in that different connection technologies are used via the port (14) for the data connection and are utilized by the operating program in the stationary computer unit (11).

19. Procedure according to claim 1, characterized in that, in case of a data exchange, an optical auxiliary means (16) built into the external data storage unit (10), especially LEDs, is activated by the data transfer.

20. Procedure according to claim 1, characterized in that the voltage pulse generated by the pulse generator (15) is temporarily stored as a change in a memory log (17) in the data storage unit (10) and is read out at a later point in time by the operating program via the existing data connection (12,13,14), with the memory log (17) being newly initialized with the read out.
